(19) United States
(12) Patent Application Publication
(10) Pub. No.: US 2002/0021309 A1
(43) Pub. Date: Feb. 21, 2002

(54) Future program action indication display

(76) Inventors: Tara Burnhouse, San Diego, CA (US); Yuko Nishikawa, La Jolla, CA (US); Dayan Golden, San Diego, CA (US)

Correspondence Address: Tom Van Zandt, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/812,417

(22) Filed: Mar. 19, 2001

Related U.S. Application Data
(60) Provisional application No. 60/215,291, filed on Jun. 30, 2000.

(51) Int. Cl. G06F 3/00

(52) U.S. Cl. 345/810

(57) ABSTRACT

Method for displaying future program information in a broadcasting system that includes a future program action indicator. According to one embodiment, future program information is provided for a plurality of future programs. The user selects one or more future programs for which action is desired. A future program actions menu is also provided from which a user selects future actions to be taken in regard to the future programs selected. An indicator is then included in the future program information display that indicates the action that will be taken in regard to the future program. In one embodiment the indicator is an action-descriptive icon.

### FIELD OF THE INVENTION

The present invention relates to the display of electronic programming guide information, and more specifically to the notation of actions to be taken with regard to future programs in a multiple channel broadcast system.

### ART BACKGROUND

Television broadcasting technology has improved tremendously since its inception. Today, television signals are broadcasted on the airwaves, through cables, and via satellite. The number of stations accessible today has increased to hundreds of stations. To select a program to view, many viewers simply “channel surf” until they find a channel that has a desirable program. Channel surfing refers to the process of using the channel “+” or “−” key to sequentially view each channel. Although some viewers find channel surfing among hundreds of stations enjoyable, most viewers prefer a more direct method for selecting a program to view.

Some prior art television channel selection guides provide a television channel selection guide which displays a listing of the channels typically in numeric order and the titles of the programs broadcasted or to be broadcasted on the channels. The viewer or user of the system may then select the channel by entering in the channel number or selecting a program. The system responds by removing the guide displayed and tuning to the station selected and displaying the broadcast signals of the station.

A viewer is provided with many options regarding programs that are available for broadcast. These options include, but are not limited to, channel surfing among program descriptions while watching a particular program on one channel, on-demand selection of pay-per-view broadcasts, selection of a broadcast for automatic recording, and programming a broadcast system to tune to a preselected station at a designated time. These options are typically accessed through graphical user interfaces. As the number of viewer options increases, so to does the need for a user-friendly system interface. The prior art channel selection guides do not provide ready indications as to the functional areas of the system interface. In addition, as the channel selection guides become more interactive and provide the viewer with more selections, the lack of distinguishing features of interactive portions of the displays can lead to a great deal of viewer frustration.

### SUMMARY OF THE INVENTION

The present invention provides a method for indicating future program action in a broadcasting system. Future program information is provided for a plurality of future programs. The user selects a future program or programs for which an action is desired. A future program actions menu is provided from which the user selects the action or actions to be taken in regard to the future program. The future program information includes an indicator that indicates the action that will be taken in regard to the future program. In one embodiment, the indicator is an action-descriptive icon.

### BRIEF DESCRIPTION OF THE DRAWINGS

The objects, features, and advantages of the present invention will be apparent to one skilled in the art from the following detailed description in which:

FIG. 1A is a simple illustration of one embodiment of the present invention;

FIG. 1B is a simple illustration of one embodiment of the present invention;

FIG. 2 illustrates an exemplary block diagram representation of elements utilized in receiving television signals, which may be used in accordance with one embodiment of the present invention;

FIG. 3 illustrates one exemplary type of data utilized to present the electronic program guide, which may be used in accordance with one embodiment of the present invention;

FIG. 4 illustrates one embodiment of pointers to the data utilized for generating an electronic program guide, which may be used in accordance with one embodiment of the present invention;

FIG. 5 illustrates an exemplary process flow diagram for annotating an action on a future program in accordance with one embodiment of the present invention;

FIG. 6a illustrates displays presented when annotating an action on a future program in accordance with one embodiment of the present invention;

FIG. 6b illustrates displays presented when annotating an action on a future program in accordance with one embodiment of the present invention;

FIG. 6c illustrates displays presented when annotating an action on a future program in accordance with one embodiment of the present invention.

### DETAILED DESCRIPTION

In the method and apparatus of the present invention the broadcast system described is a direct broadcast satellite system. However, it is readily apparent to one skilled in the art that other broadcast systems and devices which have the capability of receiving and displaying, in a realtime or a time-delay manner, a multiplicity of channels on stations may utilize the method and apparatus of the present invention. Furthermore, in the following description, for purposes of explanation, numerous details are set forth, such as menus, guides, flowcharts, and system configurations, in order to provide a thorough understanding of the present invention. However, it will be apparent to one skilled in the art that these specific details are not required in order to practice the present invention. In other instances, well-known electrical structures and circuits are shown in block diagram form in order not to necessarily obscure the present invention.

It is readily apparent to one skilled in the art that additional functions can be added to the process and functions modified or removed and still be within the spirit and scope of the invention. The system provides an innovative and user friendly access to information regarding programming available through the broadcasting system.

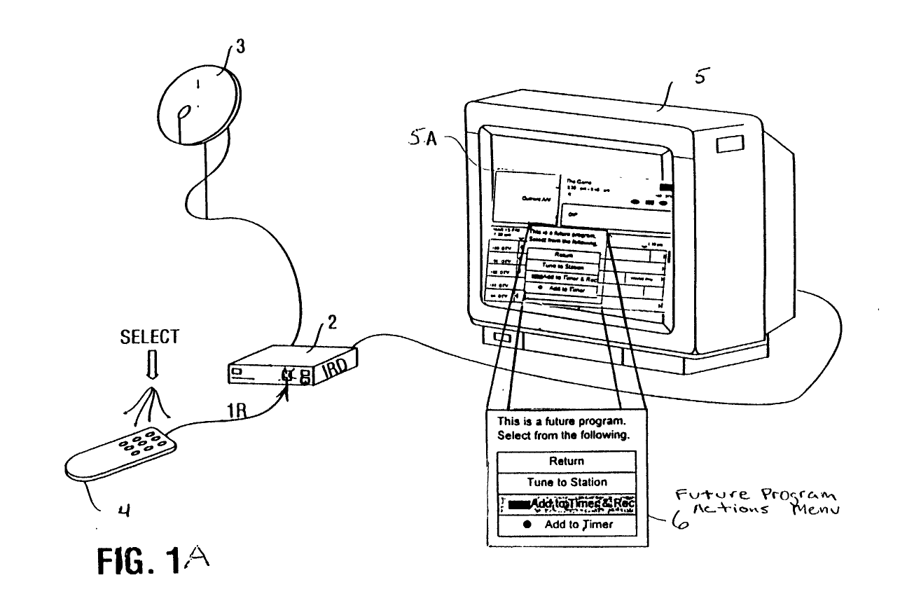

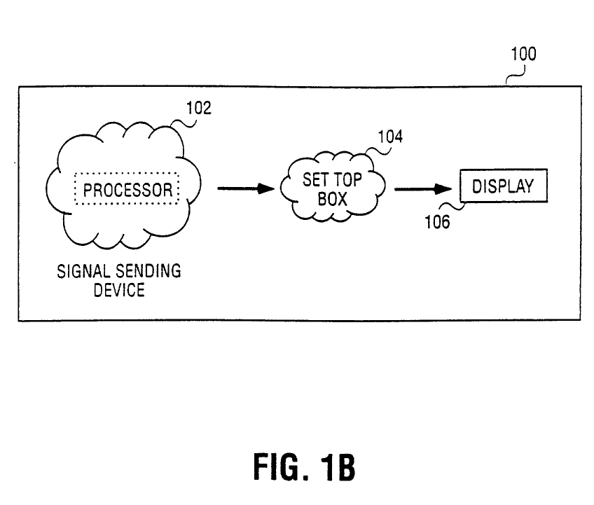

FIG. 1A is a simplified diagram illustrating an embodiment of a Direct Satellite System (DSS) for use with the present invention. The system has an antenna 3, an integrated receiver/decoder IRD2, a remote controller 4, and a display monitor 5. The display screen 5A of display monitor 5 is currently displaying a future program information display in which the user has activated the future program actions pop-up menu 6 in accordance with one embodiment of the present invention.

The antenna 3 receives an encoded data signal sent from a satellite. The received encoded signal is decoded by the IRD2. The antenna 3 has a low noise block down converter 3a (LNB) not shown in FIG. 1. The LNB 3a converts a frequency of a signal sent from the satellite to another frequency. The converted signal is supplied to the IRD2. The monitor 4 receives a signal from the IRD2.

A simplified block diagram of one embodiment of the system of the present invention is illustrated in FIG. 1B. The present embodiment illustrates a system 100, which includes a set top box controller 104, which controls a television display 106. It is readily apparent that the system is not limited to set top boxes and televisions; rather, the system also can be embodied in other types of processor-based systems including computing systems that control displays, and recording and time delay playback systems.

Referring to FIG. 1B, the system 100 includes a set top box controller 104, a signal sending device 102, and a display device 106. The set top box controller 104 controls the display of information such as broadcasts received from satellite transmissions and associated data. In addition, the controller 104 preferably includes a receiving function that operates to receive input from a signal-sending device in accordance with the teachings of the present invention. In one embodiment, a separate logic or processor may implement the signal-sending device 102.

The incoming signal data from the signal-sending device 102 may include data, such as, electronic programming guide data, as well as user preferences, and including indications when a viewer expresses interest in viewing a particular program folder or category. The set top box controller 104 can be configured to include a variety of functions known to those skilled in the art in addition to those functions described herein. Furthermore, in accordance with the teachings of the present invention, the controller 104 can be configured to store selections made by a user into its memory for allowing a user to navigate back and forth from previously made selections.

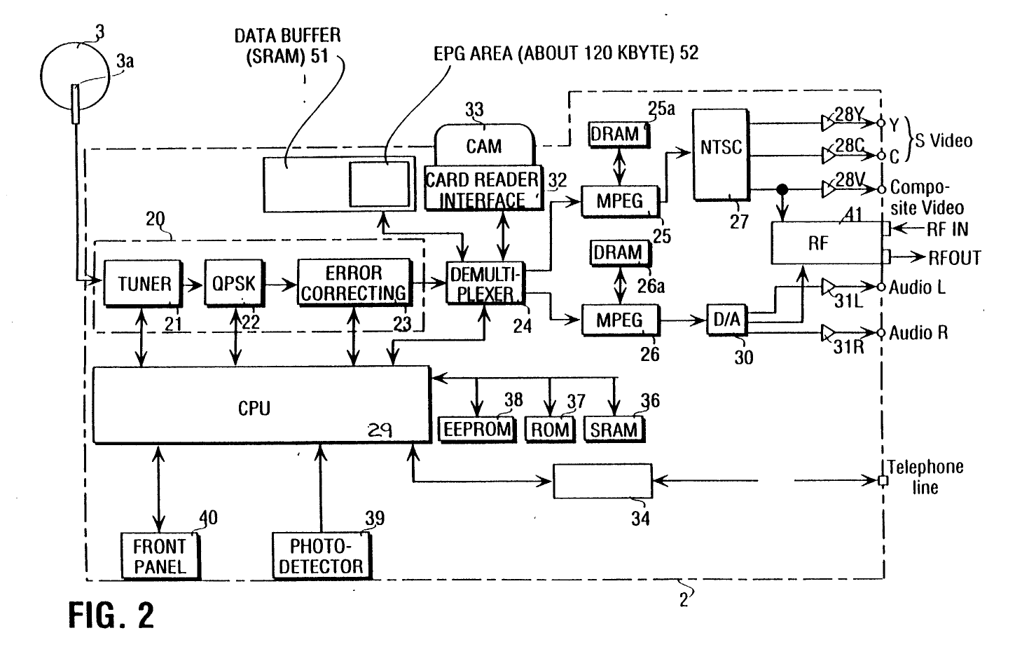

FIG. 2 is a block diagram of one embodiment of the IRD 2. A radio frequency (RF) signal output from the antenna 3 is supplied to a tuner 21 of a front end 20. The output from the tuner 21 is supplied to a quadrature phase shift keying (QPSK) demodulation circuit 22 for demodulation. The output from the QPSK demodulation circuit 22 is supplied to an error correcting circuit 23 for error correction. The data is received in encrypted and encoded (i.e., compressed) form.

The transport IC 24 receives the data stream, consisting of packets of data, from the error correcting circuit 23 and directs portions of the data stream to the appropriate circuit for processing. The digital data stream sent from a satellite includes headers for classifying the different portions of the data in the digital data stream. The transport IC stores the headers in registers and uses the headers to direct the data. In the embodiment described herein, the data stream sent from the satellite includes video data in the format specified by the Motion Pictures Expert Group standard (MPEG), MPEG audio data and electronic programming guide (EPG) data. Data that is identified by its header to be video data is transferred to MPEG video decoder 25. Data that is identified by its header to be audio data is transferred to MPEG audio decoder 26. Similarly, data having a header that identifies the data to be EPG data is transferred to a predetermined area 52 in the data buffer 51 designated to store the EPG.

A conditional access module 33, includes a central processing unit (CPU), a readonly memory (ROM) and a random access memory (RAM). The conditional access module determines whether the user has the authorization to receive certain data, e.g., audio/video for a pay TV station, using the authorization information stored in its memory. Thus, if the conditional access module determines that the user is authorized access, a key to decrypt the incoming data is provided to the transport IC 24, which decrypts the data using the key provided. In one embodiment, a smart card is utilized. This card is inserted into the card reader interface 32 for interface to the transport IC 24. It is readily apparent to one skilled in the art that the conditional access module is not limited to smart cards and may be configured in other kinds of circuitry.

The MPEG video decoder 25 decodes the video signal received from the transport IC. Dynamic random access memory (DRAM) 25a, connected to the MPEG video decoder 25, is used for buffering and storage of video data during processing by the MPEG video decoder. The decoded digital video signal is supplied to a National Television System Committee (NTSC) encoder 27 and converted to a luminance signal (Y) and a chroma signal (C) which are respectively output through a buffer amplifier 28Y or 28C as an S video signal. A composite video signal is also output through a buffer amplifier 28V.

The MPEG audio decoder 26 decodes the digital audio signal. DRAM 26a, connected to the MPEG audio decoder 26, is used for buffering of data and information during processing by the MPEG audio decoder 26. The decoded digital audio signal is converted into an analog audio signal by D/A converter 30. The left audio signal is output through buffer amplifier 31L and the right audio signal is output through buffer amplifier 31R.

An RF modulator 41 mixes a composite signal output from the NTSC encoder 27 with an analog audio signal output from the D/A converter 30. The RF modulator 41 converts the mixed signal into an RF signal and outputs the RF signal therefrom.

The CPU 29 is the central control mechanism and executes instructions code stored in memory, for example ROM 37, to perform certain functions of the system. For example, the CPU 29 processes certain data to control the generation of the folders and resultant program list in accordance with the teachings of the present invention. In addition, the CPU 29 receives and processes the user input, received from the front panel buttons or switches 40 and the photo detector circuit 39 to provide the user functionality and access to the system described herein. In addition, the CPU 29 accesses user settings/preferences for processing of information and configuration of the system. The user settings are stored in the non-volatile memory, such as electrically erasable programmable read-only memory (EEPROM) 38. In addition, the CPU 29 accesses user settings/preferences for processing of information and configuration of the system. The user settings are stored in the non-volatile memory, such as electrically erasable programmable read-only memory (EEPROM) 38. In addition, the CPU 29 maintains a list of pointers, stored in static random access memory (SRAM) 36, to the channel information and program information stored in the SRAM 51. Thus, when a user wishes to display a form of the EPG on the screen, the CPU 29, accessing pointers stored in the SRAM 36, communicates to the transport IC 34 to retrieve the data from the data buffer (SRAM) 51 identified by the pointers. The CPU then formulates the format and other digital data which forms the guide or list on the screen and forwards the data representative of the guide/list to the transport IC 34 which forwards the data to the DRAM 25a of the MPEG video decoder 25 for subsequent output to the screen.

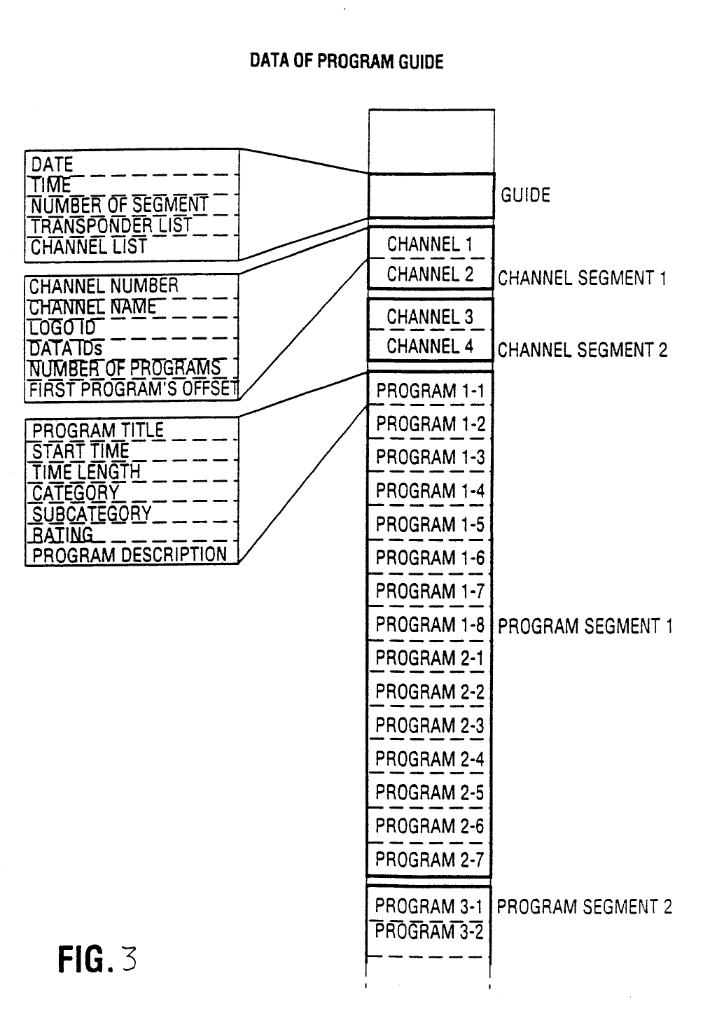

FIG. 3 is a block diagram illustration of the data stored in a portion of the data buffer RAM 51. As noted above, the RAM 51 stores EPG data including guide data, channel data, and program data. General information is included in the guide data, for example, the current date and time. The transponder list identifies the number of the transponder transmitting a segment. The channel list identifies the channel number of the first channel of a portion of data. The channel data includes data relating to channels, such as the channel number, channel name (i.e., the call sign of a broadcast station), logo ID (i.e., an identification of the channel logo), data ID, which is an identification of a channel number of MPEG video data or MPEG audio data, number of programs, which identifies the number of programs to be transmitted on a channel during a predetermined time frame, and first program offset which identifies the offset from the header to the first channel data in a segment.

The program data includes the program title, start time of the program, time length of the program, program category such as movies, news, sports, etc., program subcategory such as drama, horror, children's movies or baseball, basketball, football for the sports category, the movie rating and program description that provides a detailed description of the program.

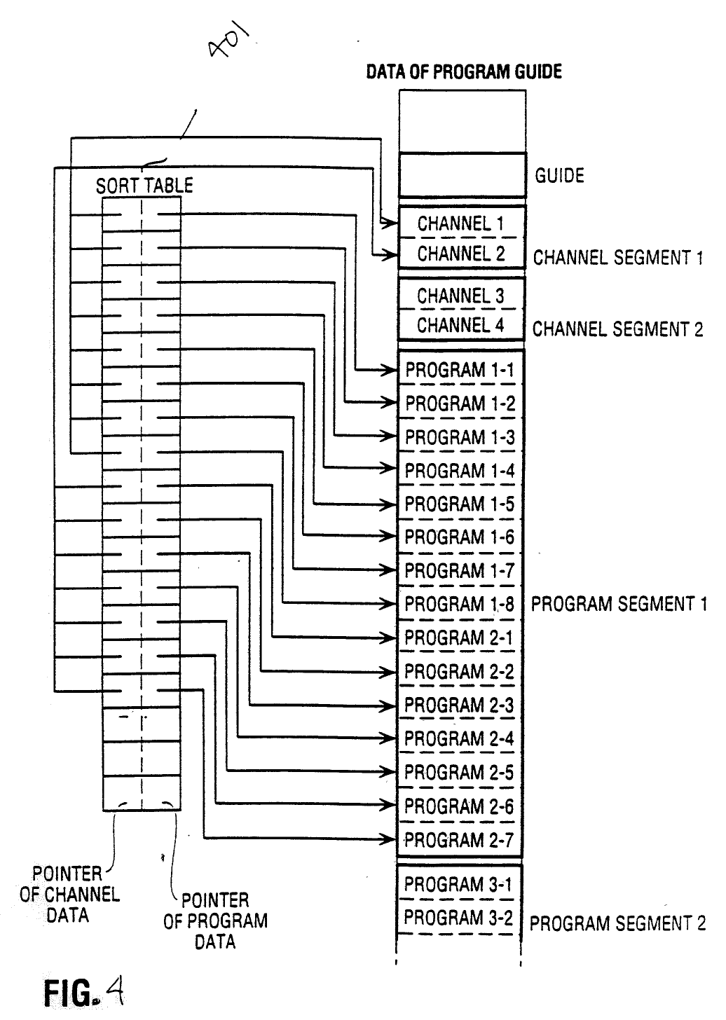

FIG. 4 illustrates how pointers to the EPG data are sorted for display on a guide on the user's television screen. As noted above, EPG data includes guide data, channel data and program data which are stored in the Data Buffer (RAM) of the IRD. When a viewer selects a channel, the CPU of the system determines the packet containing the channel information and extracts the transponder number from the channel information. The system front end starts tuning in the frequency of the designated transponder so as to receive the data transmitting from that transponder. If a viewer does not select any channel, the last channel is preferably designated.

As noted above, the CPU generates a table of pointers 401 to the EPG stored in the memory. The table 401 is used for changing the order of channels or programs according to the information to be presented in the guide to the user. The table 401 includes an entry for the address pointer to the corresponding channel data and an entry to the corresponding program data.

A table for generating display information is stored in the ROM 37. Certain data from the table is read out from the ROM 37 and stored in DRAM 25a. Preferably the data is stored in compressed form. Therefore, when a character is displayed on a screen, the compressed character array is decoded so as to generate the character to be displayed. The encoder references a dictionary, which includes a set of words and frequently used portions or words and numbers corresponding to each word or portion of a word. The encoder encodes each word to each number by using the dictionary. The decoder references the same dictionary as the encoder to perform the decode function. Once decoded, each character of the decoded word includes a character code corresponding to an American Standard Code for Information Interchange (ASCII) code. Nonvolatile memory (e.g., EEPROM 38) has two tables. The first table contains character bitmaps in the different fonts available for each character. The second table identifies the address in the first table at which to extract the character bitmap. The address is determined according to the character code. The bit map image of the character is transmitted to DRAM 25a and subsequently accessed to display the character on the screen.

In one embodiment of the present invention, the channel data is received from a predetermined transponder and the channel number and channel name are stored in DRAM 25a. Additional channel information, such as the channel logo is stored in the ROM 36. The ROM 36 preferably includes a table of Logo IDs and the address of Logo Data stored in ROM 36. Therefore, once a Logo ID is determined, the address of the Logo Data is determined, retrieved and stored in DRAM 25a.

The channel data provides the beginning address of the program data for a particular program. The actual location on the screen at which the program information is displayed is dependent upon the format of the guide. For example, in a time-based system, the location where the program title is displayed is determined by the start time and time length stored in the program data.

Using this information downloaded from the satellite transmission, programming and channel selection information is provided to the viewer. In the system and method of one embodiment of the present invention, this information is provided to the user in an innovative manner in order to enable the viewer to easily determine and select stations or programs to be viewed.

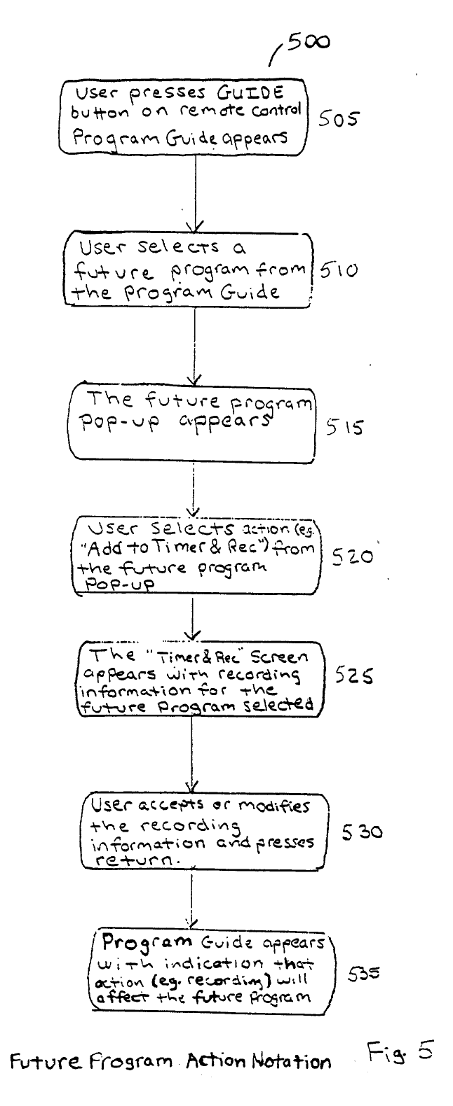

FIG. 5 is one embodiment of a process for selecting and annotating an action to be taken in regards to a future program that may be used in accordance with one embodiment of the present invention. The process 500 shown in FIG. 5 begins at operation 505 in which the user presses the GUIDE button on the remote control and the EPG display appears. This display allows the user to access pertinent information from numerous future programs as described above. In operation 510, the user selects a future program from the Program Guide and the selected program is indicated. The selected program may be indicated in various ways (e.g. highlighting). In operation 515, the Future Program Action Pop-up appears. From this display the user selects an action (e.g. Add to Timer and Rec) to affect the future program, operation 520. There are many actions that a user may desire to take in regards to a future program. The user may wish to select a future program and then be notified when the program is available, or the user may wish to set a recording device to record the future program, or perhaps the user may desire to block the display of a program. These and other actions may be set by the user to affect a future program. In an exemplary embodiment of the present invention, the EPG will display an indicator to indicate which action the user has selected for a future program. This will allow the user to be reminded of the action to be taken so that the user may rescind or modify the action. The indicator could be something as simple as a change in color of the future program information display that would indicate some action was to be taken in regards to the future program. Alternatively different colors could be assigned to specified actions or an action-descriptive icon could be used as the indicator so that the user would be aware of the action to be taken in regard to the future program.

In operation 525, the information for the action selected, for example “Timer and Rec” is displayed. In operation 530, the user accepts or modifies the information. For example, if the action desired is to record the future program, the display may show the start and stop time of the recording as well as the date. The user may wish to modify this information so that recording begins some time before the program or so that only a portion of the future program is recorded. For example the user may wish to ensure that the entire program is recorded and so set the recording time prior to the program start time of the EPG. As another example the user may wish to record only the opening monologue of a talk-show and so set the recording time well before the program end time of the EPG. The display may include the modifications made by the user. The user presses return when satisfied with the information. In operation 535 the EPG appears. The EPG display shows the selected future program that now has an indicator informing the user that the selected action will affect the selected future program. This indicator which will appear with the EPG will remind the user of what actions for future programs have been selected. This will assure the user that the action will be taken and will allow the user to add, cancel, or modify actions on future programs as desired.

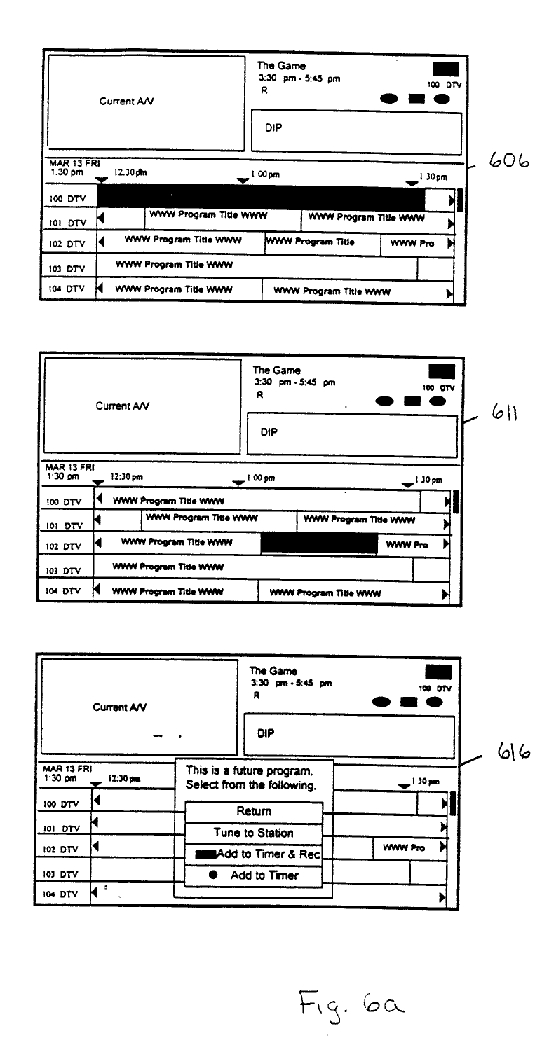

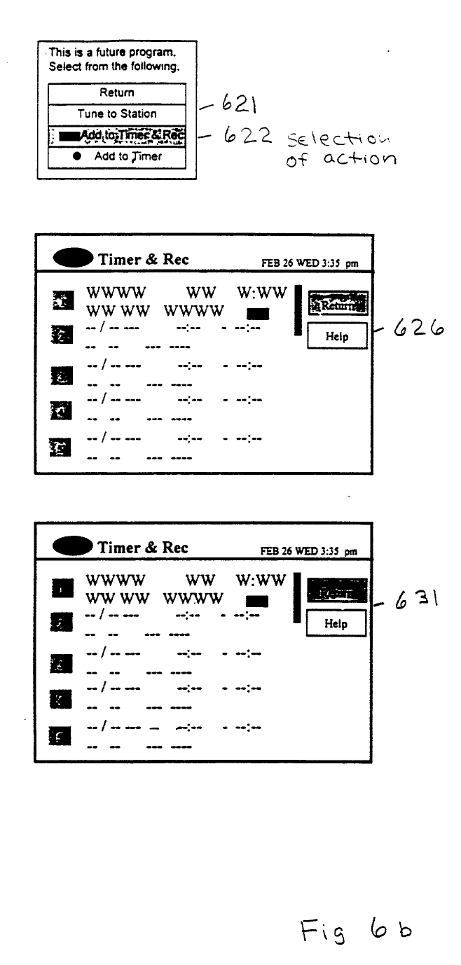

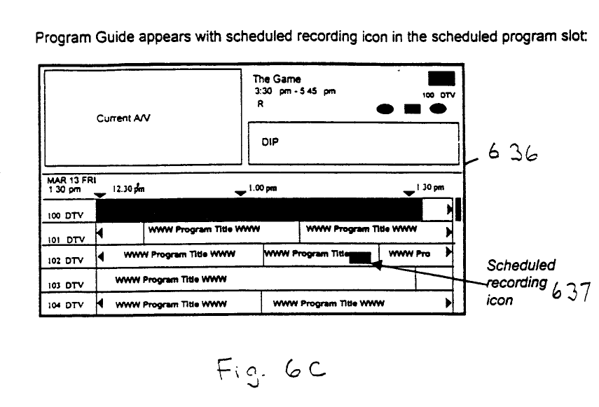

FIGS. 6a, 6b, and 6c depict the display screens the user will view throughout the process 500. The visual display designs may vary and be designed in several styles as desired.

FIG. 6a depicts display screens 606, 611, and 616 as displayed in one embodiment of the invention for operations 505, 510, and 515. In FIG. 6a, the display screen 606 is the EPG listing various future programs and the pertinent information associated with them. Screen 611 depicts the selection of a particular future program, operation 510, and screen 616 shows the Future Program Action Pop-up, operation 515.

FIG. 6b depicts display screens 621, 626, and 631 as displayed in one embodiment of the invention for operations 520, 525, and 530. In FIG. 6b, the display screen 621 is the Future Program Action Pop-up with the action to be taken in regards to the selected future program highlighted 622.

Screen 626 depicts the details of the action to be taken, in this case Timer and Record and allows the user to accept or modify the details as discussed above in relation to FIG. 5, operation 530. Screen 631 shows the user returning to the EPG.

FIG. 6c depicts display screen 636 as displayed in one embodiment of the invention for operation 535. In FIG. 6c, the display screen 636 shows the program guide. The future program selected by the user now has an indicator 637 that indicates the action that will be taken in regards to the future program. The user will be reminded of the actions to be taken in regard to future programs so that the user can be aware that the action will be taken and can, if desired, rescind or modify such actions.

In the foregoing detailed description, the methods and apparatuses of the present invention have been described with reference to specific exemplary embodiments. It should be understood that the methods and apparatuses of the invention can be practiced with modification and alteration within the spirit and scope of the appended claims. The description is thus to be regarded as illustrative instead of limiting on the invention.

What is claimed is:

1. A method for indicating future program action on a future program information display comprising:
providing future program information for a plurality of future programs, at least one future program being selected by a user;
providing, on a future program actions menu, a plurality of future program actions for the selected future program, at least one future program action being selected by the user;
receiving the selected at least one future program and the selected at least one future program action from the user; and
displaying the future program information of the selected at least one future program with an indicator such that the indicator indicates the selected at least one future program action.

2. The method of claim 1, wherein the indicator is an action-descriptive icon.

3. The method of claim 1, wherein the future program actions menu comprises features selected from the group consisting of a return feature, allowing user to navigate back to preference menu, and a help feature, allowing user to navigate to several dependent help categories, the features being able to be selected by a user.

4. The method of claim 1, wherein the selected at least one future program is indicated by highlighting.

5. The method of claim 1, wherein the future program actions menu is displayed in a popup window on the monitor display screen.

6. The method of claim 1, wherein the selected at least one future program action includes actions selected from the group consisting of recording the selected at least one future program, notifying the user of the display schedule of the selected at least one future program, and preventing the display of the selected at least one future program.

7. The method of claim 6, wherein the start and/or stop times of the selected at least one future program action does not match the start and/or stop times of the selected at least one future program.

8. The method of claim 1, wherein the future program actions menu includes a source option such the selected future program action will affect all future programs from a user-specified source.

9. A machine-readable medium that provides instructions, which when executed by at least one processor, causes the at least one processor to perform a method comprising:
providing future program information for a plurality of future programs, at least one future program being selected by a user;
providing, on a future program actions menu, a plurality of future program actions for the selected future program, at least one future program action being selected by the user;
receiving the selected at least one future program and the selected at least one future program action from the user; and
displaying the future program information of the selected at least one future program with an indicator such that the indicator indicates the selected at least one future program action.

10. The machine-readable medium of claim 9, wherein the indicator is an action-descriptive icon.

11. The machine-readable medium of claim 9, wherein the future program actions menu comprises features selected from the group consisting of a return feature, allowing user to navigate back to preference menu, and a help feature, allowing user to navigate to several dependent help categories, the features being able to be selected by a user.

12. The machine-readable medium of claim 9, wherein the selected at least one future program is indicated by highlighting.

13. The machine-readable medium of claim 9, wherein the future program actions menu is displayed in a popup window on the monitor display screen.

14. The machine-readable medium of claim 9, wherein the selected at least one future program action includes actions selected from the group consisting of recording the selected at least one future program, notifying the user of the display schedule of the selected at least one future program, and preventing the display of the selected at least one future program.

15. The machine-readable medium of claims 14, wherein the start and/or stop times of the selected at least one future program action does not match the start and/or stop times of the selected at least one future program.

16. The machine-readable medium of claim 9, wherein the future program actions menu includes a source option such the selected future program action will affect all future programs from a user-specified source.

17. A system for indicating future program action comprising:
an input to receive user input; and
a display to display programs and a processor coupled to the input and the display, the processor configured to provide future program information for a plurality of future programs, at least one future program being selected by a user, provide, on a future program actions menu, a plurality of future program actions for the selected future program, at least one future program action being selected by the user, receive the selected at least one future program and the selected at least one future program action from the user, and display the future program information of the selected at least one future program with an indicator such that the indicator indicates the selected at least one future program action.

18. The system of claim 17, wherein the indicator is an action-descriptive icon.

19. The system of claim 17, wherein the future program actions menu comprises features selected from the group consisting of a return feature, allowing user to navigate back to preference menu, and a help feature, allowing user to navigate to several dependent help categories, the features being able to be selected by a user.

20. The system of claim 17, wherein the selected at least one future program action includes actions selected from the group consisting of recording the selected at least one future program, notifying the user of the display schedule of the selected at least one future program, and preventing the display of the selected at least one future program.

21. The system of claim 20, wherein the start and/or stop times of the selected at least one future program action does not match the start and/or stop times of the selected at least one future program.

22. The system of claim 17, wherein the future program actions menu includes a source option such the selected future program action will affect all future programs from a user-specified source.

23. A display for indicating future program action comprising:
a first image to provide future program information for a plurality of future programs, at least one future program selected by the user;
a second image comprising a future program actions menu including a plurality of future program actions for the selected at least one future program; and
at least one third image comprising the future program information having a future program action indicated.

24. The display of claim 23, wherein the indicator is an action-descriptive icon.

25. The display of claim 23, wherein the future program actions menu comprises features selected from the group consisting of a return feature, allowing user to navigate back to preference menu, and a help feature, allowing user to navigate to several dependent help categories, the features being able to be selected by a user.

26. The display of claim 23, wherein the selected at least one future program action includes actions selected from the group consisting of recording the selected at least one future program, notifying the user of the display schedule of the selected at least one future program, and preventing the display of the selected at least one future program.

27. The display of claims 26, wherein the start and/or stop times of the selected at least one future program action does not match the start and/or stop times of the selected at least one future program.

28. The display of claim 23, wherein the future program actions menu includes a source option such the selected future program action will affect all future programs from a user-specified source.
